(19) United States
(12) Patent Application Publication
(10) Pub. No.: US 2010/0101340 A1
(43) Pub. Date: Apr. 29, 2010

(54) Sample collecting device

(75) Inventor: Ronald J. Lipscombe, Peterborough (CA)

Correspondence Address: Harding, Earley, Follmer & Frailey, P.C.;86 The Commons at Valley Forge East, 1288 Valley Forge Road, Post Office Box 750, Valley Forge, PA, 19482-0750, US

(73) Assignee: DNA Ident Inc., Peterborough (CA)

(21) Appl. No.: 12/589,220

(22) Filed: Oct. 20, 2009

Related U.S. Application Data
(60) Provisional application No. 61/108,200, filed on Oct. 24, 2008.

(51) Int. Cl. B01L 3/00

(52) U.S. Cl. 73/864.51

(57) ABSTRACT

A sample collecting device is provided. The sample collecting device comprises an enclosure for enclosing a collected sample therein. A connecting mechanism movable connects a sample collecting head for collecting the sample to the enclosure. The connecting mechanism holds the sample collecting head in a sampling position outside the enclosure and holds the sample collecting head in a storage position inside the enclosure. In an embodiment the sample collecting device comprises a sample access port disposed in a wall of the enclosure for enabling access to the collected sample and the enclosure is shaped such that a plurality of sample collecting devices form one of a one-dimensional and a two-dimensional array suitable for use with an automated processing machine. The sample collecting device further comprises an identifier for providing identification data to the automated processing machine.

### FIELD OF THE INVENTION

This application claims the benefit of U.S. Provisional Patent Application No. 61/108,200 filed Oct. 24, 2008, the entire contents of which are incorporated herein by reference.

The instant invention relates to the collection of samples and in particular to a sample collecting device for collecting, transporting, storing, and processing of samples.

### BACKGROUND

Typically, sample collecting devices are used for: collecting samples such as, for example, biological or chemical samples; for transporting the samples to a laboratory for analysis; and for storing the collected samples. Biological samples include, for example, hair, blood, saliva, buccal cells or other bodily fluids and tissues. Samples are collected in numerous locations in the field such as, for example, in medical clinics and hospitals, on farms, in food processing facilities, and at crime scenes.

Currently, various types of sample collecting devices are used such as, for example, test tubes, poly bags, or sampling envelopes. When working in the field the existing sample collecting devices typically require handling of at least two separate components. For example, a sample collecting head such as, for example, a DNA collection swab, is used to collect the sample. After collecting the sample the swab is placed into a test tube which is then closed using a plug. In numerous applications handling of the separate components is a tedious task and provides a substantial risk of contamination.

Furthermore, for analyzing the samples the existing sample collecting devices require transfer of the collected samples from the sample collecting device onto, for example, multi-well plates of automated sample processing machines. The transfer of the collected samples is highly labour intensive and provides a substantial risk of cross contamination.

Due to increasing food safety concerns the ear tagging of livestock combined with DNA sample collection has become standard practice in industrialized countries. Unfortunately, the DNA collection during the ear tagging process using existing sample collecting devices is a difficult task—in particular the handling of the separate components when wearing gloves during the ear tagging process—and provides a substantial risk of contamination.

Using existing sample collecting devices identification is typically provided by handwriting onto the sample collecting container or a label attached thereto. Alternatively, a barcode label is attached to the container. For analyzing the samples the information of each container is then separately read and provided to the automated sample processing machine—using a barcode reader or human intervention—providing a risk of errors.

In various applications such as, for example, forensics and food safety, tampering is a serious concern, which is not addressed by existing sample collecting devices. Existing sample collecting devices such as, for example, test tubes, poly bags, or envelopes, allow access to the collected sample without leaving evidence.

It is desirable to provide a sample collecting device that is substantially easily handled in the field.

It is also desirable to provide a sample collecting device that is handled by automated sample processing machines.

It is also desirable to provide a sample collecting device that facilitates identification in automated sample processing.

It is also desirable to provide a sample collecting device that is tamper evident.

### SUMMARY OF EMBODIMENTS OF THE INVENTION

In accordance with embodiments of the present invention there is provided a sample collecting device. The sample collecting device comprises an enclosure for enclosing a collected sample therein and a sample collecting head for collecting the sample. A connecting mechanism movable connects the sample collecting head to the enclosure. The connecting mechanism holds the sample collecting head in a sampling position outside the enclosure and holds the sample collecting head in a storage position inside the enclosure.

In accordance with embodiments of the present invention there is further provided a sample collecting device. The sample collecting device comprises an enclosure for enclosing a collected sample therein. A sample holding mechanism disposed inside the enclosure holds the collected sample at a predetermined location within the enclosure. A sample access port disposed in a wall of the enclosure enables access to the collected sample at the predetermined location. The sample access port is sized such that an end portion of a tool is enabled to access the collected sample.

In accordance with embodiments of the present invention there is yet further provided a sample collecting device. The sample collecting device comprises an enclosure for enclosing a collected sample therein. The enclosure is shaped such that a plurality of sample collecting devices forms one of a one-dimensional and a two-dimensional array suitable for use with an automated processing machine. A sample holding mechanism disposed inside the enclosure holds the collected sample at a predetermined location within the enclosure.

In accordance with embodiments of the present invention there is yet further provided a sample collecting device. The sample collecting device comprises an enclosure for enclosing a collected sample therein. A tag is removable connected to the enclosure. The tag is for being attached to an object associated with the collected sample. A first identifier is connected to the enclosure and a second identifier is connected to the tag with the second identifier being correlated to the first identifier.

In accordance with embodiments of the present invention there is yet further provided a sample collecting device. The sample collecting device comprises a first enclosure portion having a first fastening mechanism and a second enclosure portion having a second fastening mechanism. The second fastening mechanism mates with the first fastening mechanism to fasten the second enclosure portion to the first enclosure portion in order to form an enclosure for enclosing a collected sample therein, wherein the second enclosure portion is fastened to the first enclosure portion in a substantially tamper evident fashion.

### BRIEF DESCRIPTION OF THE DRAWINGS

Exemplary embodiments of the invention will now be described in conjunction with the following drawings, in which:

FIG. 1a is a simplified block diagram illustrating in a perspective view a sample collecting device according to a preferred embodiment of the invention, with the sample collecting head being hold in a sampling position;

FIGS. 1b and 1c are simplified block diagrams illustrating in cross sectional views the sample collecting device according to a preferred embodiment of the invention, with the sample collecting head being hold within the enclosure and in a storage position, respectively;

FIG. 1d is a simplified block diagram illustrating in a cross sectional view the sample collecting device according to a preferred embodiment of the invention, with a sealing element disposed between the first and the second enclosure portion;

FIG. 1e is a simplified block diagram illustrating in a cross sectional view the sample access port of the sample collecting device according to a preferred embodiment of the invention, with the sample access port being accessed by a tool;

FIGS. 2a to 2c are simplified block diagrams illustrating in cross sectional views embodiments of the sample access port of the sample collecting device according to a preferred embodiment of the invention;

FIGS. 3a and 3b are simplified block diagrams illustrating in a bottom view and a top view an array of the sample collecting device according to a preferred embodiment of the invention;

FIG. 3c is a simplified block diagram illustrating in a top view another array of the sample collecting device according to a preferred embodiment of the invention;

FIG. 4a is a simplified block diagram illustrating in a top view a sample collecting head of the sample collecting device according to a preferred embodiment of the invention;

FIGS. 4b and 4c are simplified block diagrams illustrating employment of the sample collecting head shown in FIG. 4a in an ear tagging process;

FIG. 4d is a simplified block diagram illustrating in a cross sectional view an interface for mounting a sample collecting head to the sample collecting device according to a preferred embodiment of the invention;

FIG. 5 is a simplified block diagram illustrating in a bottom view a tag removable connected to the sample collecting device according to a preferred embodiment of the invention; and,

FIGS. 6a and 6b are simplified block diagrams illustrating in a cross sectional view a fastening mechanism of the sample collecting device according to a preferred embodiment of the invention.

### DETAILED DESCRIPTION OF EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

While the description of the preferred embodiments herein below is with reference to a sample collecting device for collecting biological samples for DNA analysis, it will become evident to those skilled in the art that the embodiments of the invention are not limited thereto, but are also applicable for collecting various other biological or chemical samples.

While the description of various features herein below is with reference to a preferred embodiment of a sample collecting device, it will become evident to those skilled in the art that the features of the invention are not limited thereto, but are also applicable in various combinations and with various other sample collecting devices.

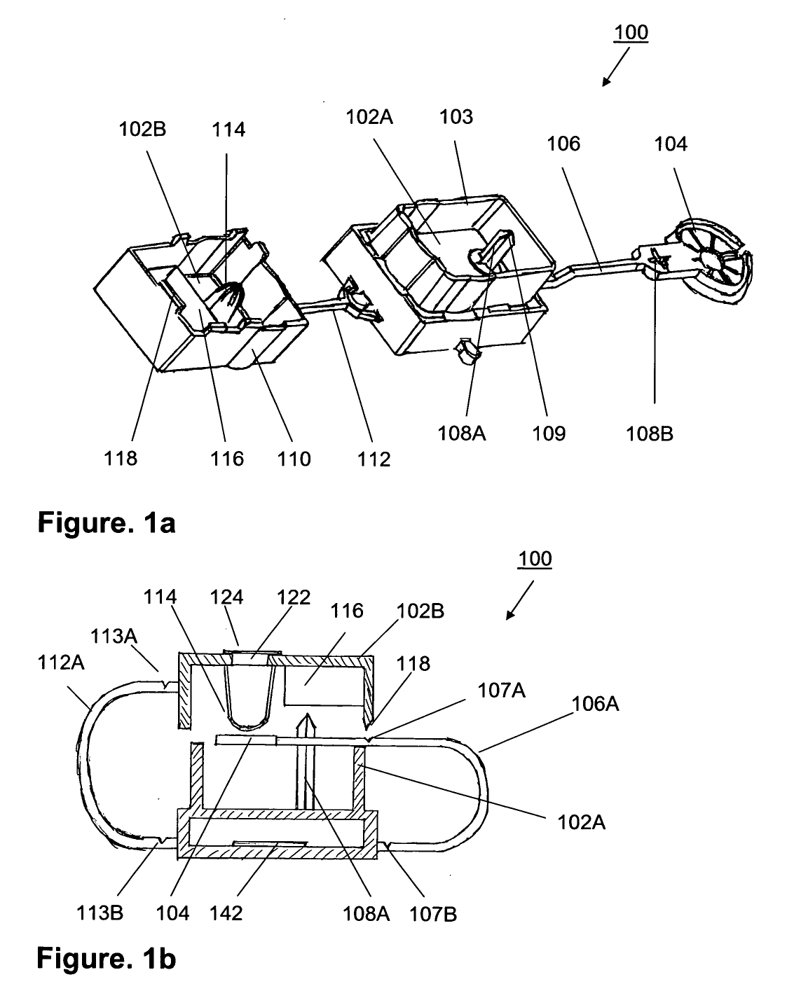

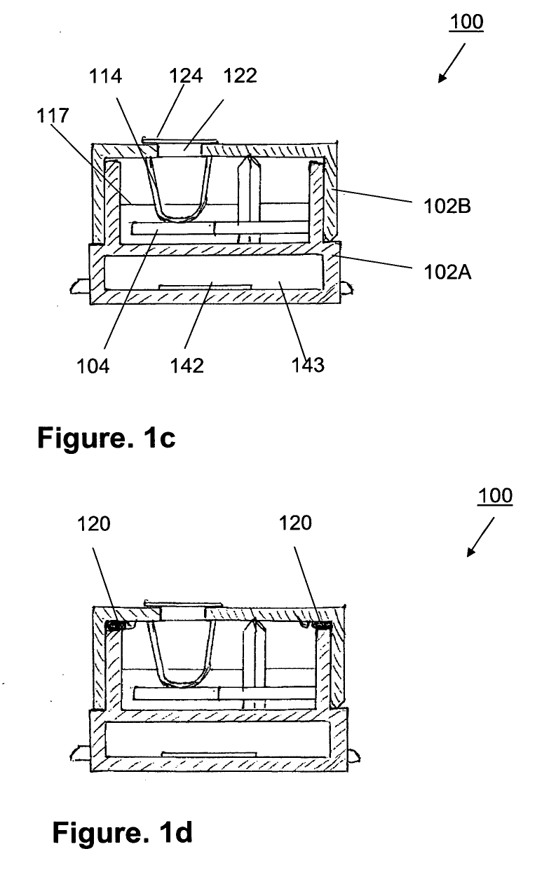

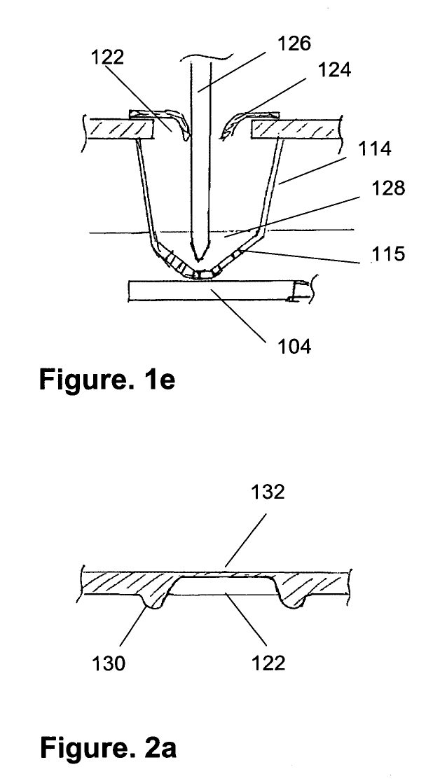

Referring to FIGS. 1a to 1e, a sample collecting device 100 according to a preferred embodiment of the invention is provided. The sample collecting device 100 comprises an enclosure 102A and 102B for enclosing a collected sample therein. Preferably, the enclosure comprises a first enclosure portion 102A—forming a receptacle—and a second enclosure portion 102B—forming a lid. Sample collecting head 104 is connected to the first enclosure portion 102A via connecting mechanism 106. The connecting mechanism 106 holds the sample collecting head 104 in a sampling position outside the enclosure for collecting a sample, as illustrated in FIG. 1a, and holds the sample collecting head 104 in a storage position inside the enclosure, as illustrated in FIG. 1c. The enclosure has a first holding element 108A disposed therein. For example, the first holding element 108A is formed as a protrusion—having a cross shaped cross-section and a tapered tip portion 109—which is integral with the first enclosure portion 102A. The connecting mechanism 106 has a second holding element 108B placed in proximity to the sample collecting head 104. The second holding element 102B engages the first holding element 108A for holding the sample collecting head in the storage position. For example, the second holding element 108B comprises a cross shaped aperture for accommodating the protrusion 108A, having a cross shaped cross-section, therein.

Preferably, the connecting mechanism 106 is connected to an outside of the first enclosure portion 102A, as illustrated in FIGS. 1a and 1b, enabling disposal of the sample collecting head at a predetermined distance to the enclosure for facilitating sample collection, for example, during an ear tagging process. Further preferably, the connecting mechanism 106 comprises at least a portion that is bendable which provides a simple mechanism for moving the sample collecting head 104 from the sampling position to the storage position by just bending the connecting mechanism 106 and engaging the second holding element 108B with the first holding element 108A, as illustrated in FIG. 1b. For example, the connecting mechanism 106 comprises a slender elongated body made of a flexible material such as a plastic material. Suitable plastic materials are, for example, nylon, polypropylene, and polystyrene. Preferably, the first enclosure portion 102A, the sample collecting head 104 and the connecting mechanism 106 are manufactured as a single unit using state of the art plastic molding techniques. Alternatively, the connecting mechanism is mounted to the first enclosure portion 102A and the sample collecting head 104 using an adhesive or a tight fit interface. The engagement is facilitated by providing the tapered tip portion 109 of the first holding element 108A. After the engagement of the second holding element 108B with the first holding element 108A, the sample collecting head 104 is hold inside the first enclosure portion 102A.

Alternatively, the connecting mechanism 106 is made of a substantially rigid material and comprises a hinge mechanism for enabling movement of the sample collecting head.

For closing the sample collecting device 100, the second enclosure portion 102B is mated with the first enclosure portion 102A. For example, the first enclosure portion 102A is provided with an engaging wall 103 for engaging wall 110 of the second enclosure portion and providing a tight fit to substantially seal the enclosure in a liquid tight fashion, as illustrated in FIG. 1c. Alternatively, a sealing element such as, for example, O-ring 120, is provided, as illustrated in FIG. 1d.

Preferably, a portion 106A of the connecting mechanism 106 is removable, for being removed after the sample collecting head is held in the storage position, by providing weakened sections 107A and 107B at predetermined locations for breaking or cutting the portion 106A off. For example, the second enclosure portion 102B comprises a cutting mechanism 118 such as, for example, a cutting edge, for severing the portion 106A at section 107A when the second enclosure portion 102B is mated with the first enclosure portion 102A, as illustrated in FIG. 1b, and the portion 106A is then removed by bending the portion 106 about the section 107B. The cutting edge comprises, for example, a tapered portion of the engaging wall 110. Alternatively, a cutting edge is mounted, for example, to the engaging wall 110. Optionally, a support such as, for example, an increased thickness of the engaging wall 103, is provided at the location where the connecting mechanism 106 is severed by the cutting mechanism 118.

Preferably, the second enclosure portion 102B is connected to the first enclosure portion 102A via a bendable connecting mechanism 112, as illustrated in FIG. 1a. Provision of weakened sections 113A and 113B at predetermined locations enable removal of portion 112A of the connecting mechanism 112 after the second enclosure portion 102B is mated with the first enclosure portion 102A, as illustrated in FIGS. 1b and 1c.

Alternatively, the second enclosure portion 102B is connected to the first enclosure portion 102A in a different fashion using, for example, a hinge mechanism or a gliding mechanism.

Preferably, the sample collecting device 100 is shaped having substantially rectangular walls and is sized such that handling during sample collection is facilitated, but is not limited thereto. As is evident to one skilled in the art, various different shapes and sizes are employable depending, for example, on the application and the size of the sample.

Preferably, the first enclosure portion 102A, the second enclosure portion 102B, the sample collecting head 104 and the connecting mechanisms 106 and 112 are manufactured as a single unit using, for example, standard plastic molding techniques for molding standard plastic materials such as nylon, polypropylene, and polystyrene.

Optionally, preservation liquid is provided in preservation container 116 disposed inside the enclosure. For example, the preservation liquid container 116 is made of a pierceable film material and heat sealed. The preservation liquid container 116 is then mounted to the inside of the second enclosure portion 102B using, for example, an adhesive. When the second enclosure portion is mated with the first enclosure portion 102A a piercing element such as, for example, the tip 109 of the protrusion 108A pierces the preservation container 116 and the preservation liquid 117 is released covering the collected sample, as illustrated in FIGS. 1b and 1c.

Preferably, the sample collecting device 100 comprises a sample access port 122 placed in a wall of the enclosure for enabling access to the collected sample disposed on sample collecting head 104 which is hold at a predetermined location within the enclosure by the holding elements 108A and 108B. For example, the sample access port 122 is sealed using a pierceable membrane 124 which is bonded to the enclosure wall. The sample access port 122 is disposed at a predetermined location and sized such that an end portion of a tool 126 such as, for example, a pipette tip, of an automated sample processing machine is enabled to access the collected sample. During automated processing the end portion of the tool 126 is aligned with the sample access port 122 and pierces through the membrane 124, as illustrated in FIG. 1e, to access the collected sample, for example, for adding reagents or aliquotting.

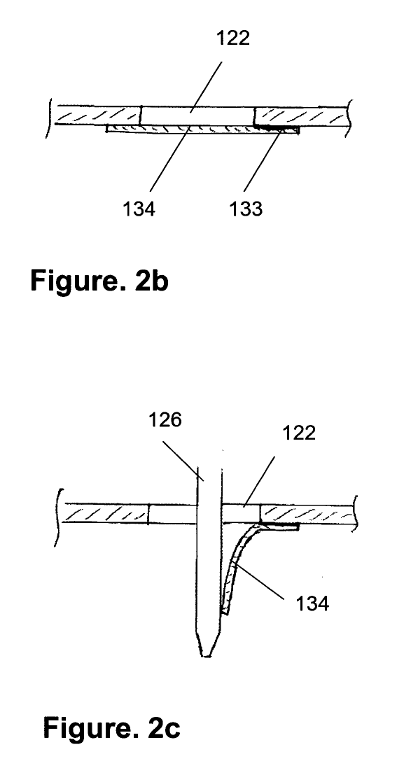

Alternatively, the sample access port 122 is provided, for example, as an integral part of the wall of the second enclosure portion 102B, for example, formed as rim structure 130 surrounding the sample access port 122 and an integrated seal 132 formed as a thin portion of the wall of the second enclosure portion 102B, as illustrated in FIG. 2a. The thin portion 132 is designed such that it is pierceable by the end portion of the tool 126. Further alternatively, the sample access port 122 is sealed, for example, using a flexible membrane 134—made of, for example, rubber or plastic material—having a portion 133 bonded to the wall of the second enclosure portion 102B and a remaining portion being in contact with the wall, as illustrated in FIG. 2b. For accessing the collected sample, the end portion of the tool 126 pushes the remaining portion downward, as illustrated in FIG. 2c. After the end portion of the tool 126 is retracted the remaining portion of the flexible membrane 134 moves back and in contact with the wall.

Optionally, a filter mechanism 114 is disposed in proximity of the sample access port 122 such that a portion of the collected sample is filtered prior removal by the tool 126, as illustrated in FIGS. 1c and 1e. The filter mechanism 114 comprises, for example, a protrusion surrounding the sample access port 122 and extending from the upper wall of the second enclosure portion 102B a predetermined distance such that a portion of the collected sample is filtered and accumulated within the protrusion, enabling the tool 126 to access the filtered portion 128 for removal, as illustrated in FIG. 1e. The filter mechanism comprises, for example, the protrusion formed as an integral part of the second enclosure portion 102B having apertures 115 of predetermined size placed at predetermined locations in a bottom portion of the protrusion. Alternatively, the filter mechanism 114 comprises a structure outlining the protrusion and having a filter element such as, for example, a sieve or porous membrane attached thereto. Further alternatively, the filter element is shaped to form the protrusion and is attached to the upper wall of the second enclosure portion 102B. Provision of the filtering mechanism 114 prevents, for example, solids such as pieces of tissue from being drawn into a pipette tip when the collected sample is accessed by the tool 126.

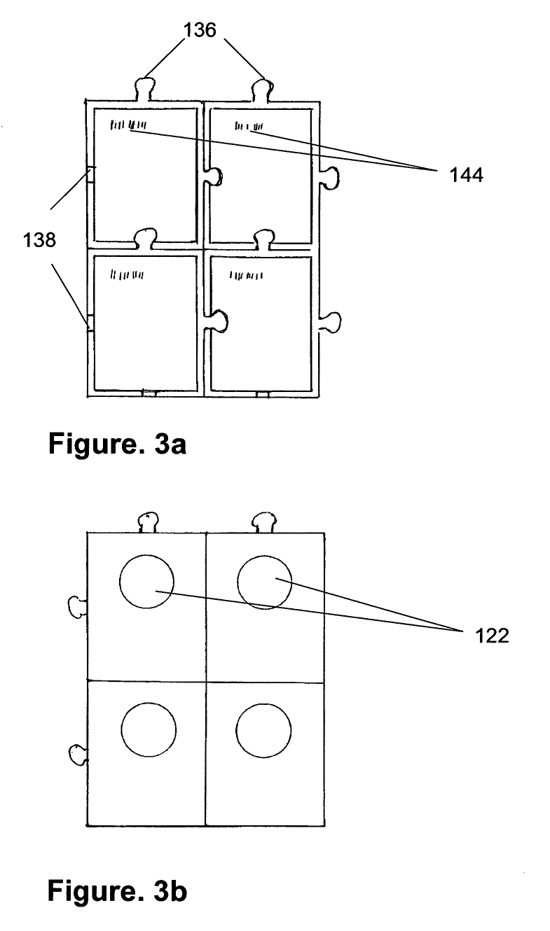

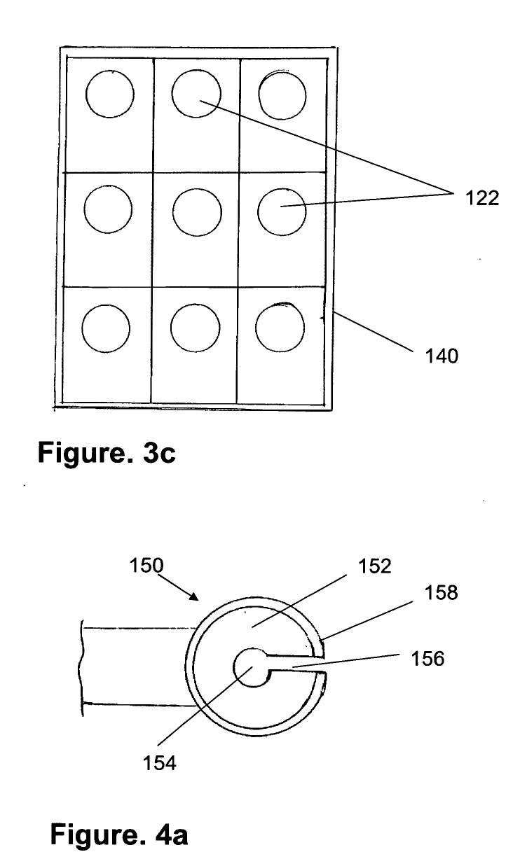

Preferably, the enclosure of the sample collecting device 100 is shaped such that a plurality of the sample collecting devices 100 form one of a one-dimensional and a two-dimensional array—or multi-well plate—suitable for use with a state of the art automated processing/analysis machine. For example, a bottom portion of the first enclosure portion 102A is shaped—for example, rectangular—such that the sample collecting devices 100 are placed side by side to form the array, as illustrated in FIG. 3a. The sample collecting device 100 comprises a coupling mechanism for coupling the sample collecting device 100 with at least an adjacent sample collecting device 100. The coupling mechanism comprises a first coupling element and a second coupling element such as, for example, a protrusion 136 and an aperture or recess 138, respectively, disposed on an outside perimeter of the bottom portion of the first enclosure portion 102A. The protrusion 136 and the recess 138 are shaped to provide a snug fit. The protrusion 136 is coupled with a respective recess 138 of an adjacent sample collecting device and the recess 138 is coupled with a respective protrusion of another adjacent sample collecting device 100. For example, two protrusions 136 and two recesses 138 are provided such that the sample collecting devices 100 have a same orientation when coupled to form a two-dimensional array, as illustrated in FIG. 3a. The sample collecting devices 100 are designed such that the sample access ports 122 are at predetermined locations of the array, as illustrated in FIG. 3b, in order for the array of sample collecting devices 100 to form a multi-well plate for automated processing. Optionally, the coupling elements are provided such that the sample collecting devices 100 are handled and coupled using an automated processing machine.

Alternatively, the coupling mechanism is omitted and the sample collecting devices 100 are arranged in an array by placing them in a tray 140 for automated processing, as illustrated in FIG. 3c.

Further alternatively, other coupling mechanisms are provided such as, for example, magnets, hook-and-loop fasteners such as Velcro®, or snap fasteners, disposed on the perimeter of the bottom portion of the first enclosure portion 102A.

Preferably, the sample collecting device 100 comprises an identifier for providing identification data to the automated processing machine with the identification data being collected by the automated processing machine. For example, the identifier is a unique sequence of symbols—such as, for example, numbers and/or characters—uniquely identifying a single sample collecting device 100. As illustrated in FIGS. 1b and 1c, a Radio Frequency Identification (RFID) chip 142 is disposed in the enclosure of the sample collecting device 100. The RFID chip 142 comprises circuitry for generating and emitting a RF signal indicative of the identifier. The RFID chip 142 is, for example, accommodated in a cavity 143 of the enclosure, embedded within a wall portion of the enclosure using standard plastic molding techniques or bonded to a wall portion of the enclosure using a suitable adhesive. Alternatively, an optically readable identifier—for example, a barcode 144—is disposed at a suitable location—for example, a bottom wall portion—of the enclosure, as illustrated in FIG. 3a. The optically readable identifier is disposed, for example, using a label bonded to the wall portion. The identification data are collected by the automated processing machine having a RF receiver or a barcode reader prior coupling of the sample collecting devices 100 or when coupled forming a multi-well plate.

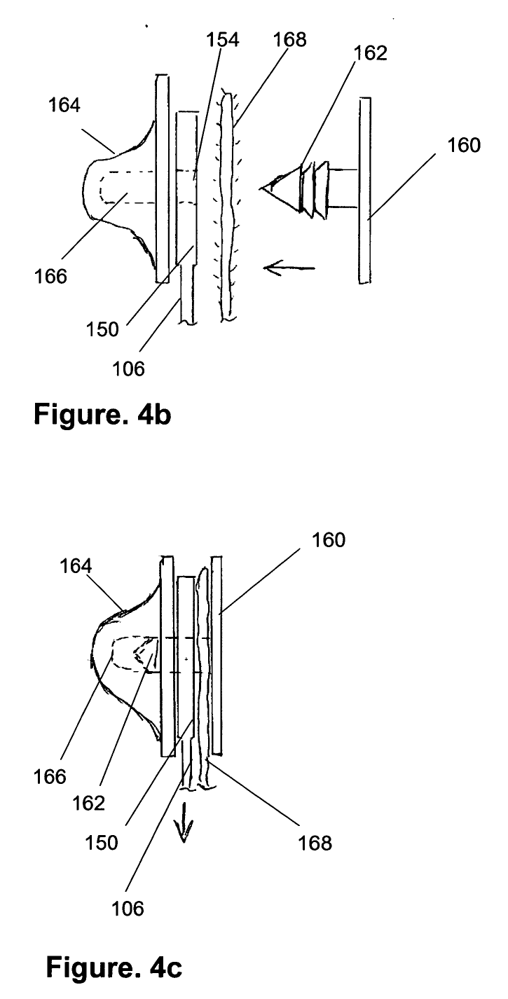

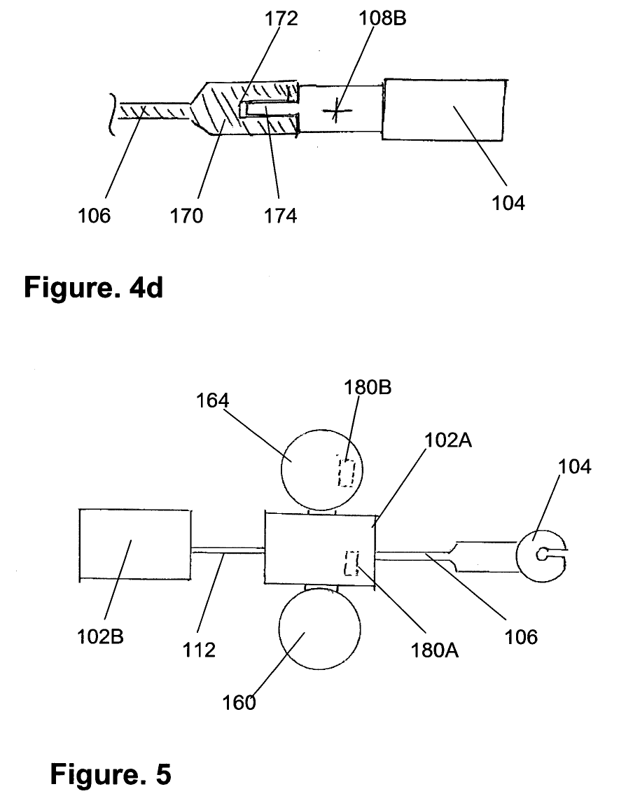

Referring to FIGS. 4a to 4c, a sample collecting head 150 for collecting a blood sample during an ear tagging process of livestock and for use with the sample collecting device 100 is shown. The sample collecting head 150 comprises a flexible plate structure 152 for collecting the blood sample thereupon. The flexible plate structure 152 has an aperture 154 which is sized for accommodating a piercing shaft 162 of an ear tag backing 160 therein. The flexible plate structure 152 further comprises a passage 156 connected to the aperture 154 for releasing the piercing shaft 162 of the ear tag backing 160. Preferably, the sample collecting head comprises a flexible reinforcing ring structure 158 surrounding the flexible plate structure 152. The sample collecting head 150 is made of, for example, a flexible plastic material and manufactured together with the enclosure 120 and the connecting mechanism 106 as a single unit. Optionally, the flexible plate structure is made of an absorbent material or an absorbent material is disposed on the flexible plate structure 152. As illustrated in FIG. 4a, the flexible plate structure 152 is of disc shape, but is not limited thereto and other shapes such as, for example, rectangular shape, are also employable.

In an ear tagging process, as illustrated in FIGS. 4b and 4c, the sample collecting head 150—connected to the sample collecting device 100 via connecting mechanism 106—is provided together with an ear tag front disc 164—for example, clamped together using a mount of an ear tag applicator (not shown). The ear tag backing 160 is mounted to a pin of the ear tag applicator. During attachment of the ear tag, the piercing shaft 162 pierces through the ear 168, moves through the aperture 154 and into bore 166 of the front disc 164 where the piercing shaft 162 is accommodated therein in an un-releasable fashion. Blood drawn during the piercing of the ear is collected upon the flexible plate structure 152. After the piercing of the ear and prior the final attachment of the ear tag the sample collecting head 150 is pulled such that the piercing shaft 162 is released through the passage 156, as illustrated in FIG. 4c.

As is evident to one skilled in the art, there numerous other sample collecting heads employable with the sample collecting device 100. Examples of employable sample collecting heads are: a swab (for example, a cotton swab or absorbent plastic disc) for collecting fluid samples such as sweat, blood, buccal cells; a grasping device (for example, tweezers) for collecting solid materials such as hair or teeth; a coring device for collecting portions of a solid object such as an organ; or an adhesive surface for collecting fine solid particles such as pollen.

Optionally, the connecting mechanism 106 comprises a sample collecting head interface 170 for variably providing one of a plurality of different sample collecting heads 104. For example, interface element 172—such as a bore—disposed in an end portion of the connecting mechanism 106 accommodates in a snug fit therein a respective interface element 174—such as a rod—connected to the second holding element 108B, as illustrated in FIG. 4d. Further optionally, using the sample collecting head interface 170 the connecting mechanism 106 is disconnected from the sample collecting head 104 after the sample collecting head is placed within the enclosure and the second holding element 108B is interfaced with the first holding element 108A, obviating severing of the connecting mechanism 106 from the sample collecting head 104.

Referring to FIG. 5, another embodiment of the sample collecting device 100 according to the invention is provided. The sample collecting device comprises enclosure 102A, 102B with the sample collecting head 104 connected to the first enclosure portion 102A via connecting mechanism 106. The enclosure—for example, the first enclosure portion 102A—has removable connected thereto a tag such as, for example, an ear tag 160, 164. Prior use, the ear tag 160, 164 is removed from the enclosure 102A and attached to the ear of the animal the sample is collected therefrom, thus associating the collected sample with the animal the sample was taken from. A first identifier is connected to the first enclosure portion—for example, RFID chip 180A is, for example, embedded in the first enclosure portion 102A—and a second identifier is connected to the tag 164—for example, RFID chip 180B is embedded in the tag 164. The second identifier is correlated to the first identifier—for example, the RFID chips 180A and 180B comprise circuitry for generating and emitting an RF signal indicative of a same identifier. The sample connecting device and the tag are, for example, manufactured as a single unit using standard plastic molding techniques. Alternatively, optically readable identifiers—for example, in the form of a barcode—are disposed at a suitable location on the outside of the enclosure and the tag. As is evident to one skilled in the art, the embodiment is not limited for use with ear tags but also applicable for use with various other tags or labels for being attached to an object a sample has been collected from. Further alternatively, an RFID chip for generating and emitting an RF signal indicative of a same identifier is provided with the sample collecting device 100 for insertion into an animal for microchip identification.

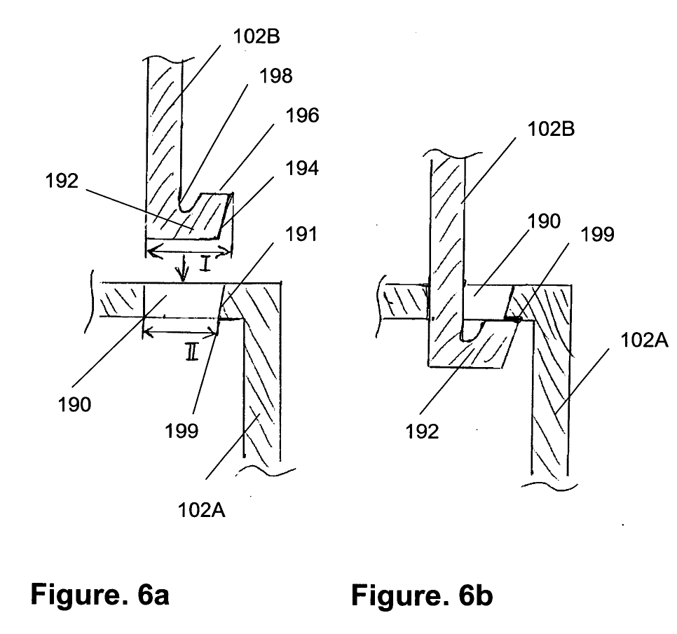

Referring to FIG. 6, yet another embodiment of the sample collecting device 100 according to the invention is provided. The sample collecting device comprises a first enclosure portion 102A having a first fastening mechanism 190 and a second enclosure portion 102B having a second fastening mechanism 192. The first fastening mechanism 190 mates with the second fastening mechanism to fasten the second enclosure portion 102B to the first enclosure portion 102A in order to form an enclosure for enclosing a collected sample therein. The second enclosure portion 102B is fastened to the first enclosure portion 102A in a substantially tamper evident fashion. For example, the first fastening mechanism 190 comprises a first locking element in the form of an aperture and the second fastening mechanism 192 comprises a second locking element in the form of a tab having a slanted surface 194, an interacting surface 196, and a recess 198, as illustrated in FIGS. 6a and 6b. Distance I of the tab 192 is slightly larger than distance II of the aperture 190. When mating the tab 192 with the aperture 190 pressure is applied—by pressing the first enclosure portion 102A and the second enclosure portion 102B together—and the tab 192 is slightly flexed about the recess 198 when pushed through the aperture 190. When mated, the interacting surface 196 of the tab interacts with respective interacting surface 199, as illustrated in FIG. 6b. For disengaging the tab 192 from the aperture 190 the tab 192 is severed in proximity to the recess 198, thus providing evidence that the enclosure 102A, 102B has been opened. Optionally, surface 191 of the aperture is slanted for facilitating mating of the tab 192 with the aperture 190, as illustrated in FIGS. 6a and 6b. A plurality of apertures 190 and tabs 192 are disposed at predetermined locations of the first enclosure portion 102A and the second enclosure portion 102B, respectively, such that the first enclosure portion 102A is securely mated with the second enclosure portion 102B. Preferably, the apertures 190 and tabs 192 are disposed such that the interacting surfaces 196 and 199 are disposed inside the enclosure. Optionally, each enclosure portion comprises at least an aperture 190 and at least a tab 192.

Alternatively, the first enclosure portion 102A is mated with the second enclosure portion 102B in a different tamper evident fashion, for example, by releasing an adhesive during the mating process for bonding the first enclosure portion 102A with the second enclosure portion 102B.

The present invention has been described herein with regard to preferred embodiments. However, it will be obvious to persons skilled in the art that a number of variations and modifications can be made without departing from the scope of the invention as described herein.

What is claimed is:

1. A sample collecting device comprising:
an enclosure for enclosing a collected sample therein;
a sample collecting head for collecting the sample; and,
a connecting mechanism movable connecting the sample collecting head to the enclosure, the connecting mechanism for holding the sample collecting head in a sampling position outside the enclosure and for holding the sample collecting head in a storage position inside the enclosure.

2. A sample collecting device as defined in claim 1 wherein the enclosure has a first holding element disposed therein and the connecting mechanism has a second holding element placed in proximity to the sample collecting head, the second holding element for engaging the first holding element for holding the sample collecting head in the storage position.

3. A sample collecting device as defined in claim 1 wherein at least a portion of the connecting mechanism is bendable.

4. A sample collecting device as defined in claim 1 wherein the connecting mechanism is connected to an outside of the enclosure.

5. A sample collecting device as defined in claim 4 wherein a portion of the connecting mechanism is removable for being removed after the sample collecting head is held in the storage position.

6. A sample collecting device as defined in claim 5 wherein the enclosure comprises a first enclosure portion having the sample collecting head connected thereto and a second enclosure portion, the second enclosure portion for being mated with the first enclosure portion to form the enclosure, the first enclosure portion and the second enclosure portion comprising a cutting mechanism for severing a first portion of the connecting mechanism disposed inside the enclosure from a second portion of the connecting mechanism disposed outside the enclosure.

7. A sample collecting device as defined in claim 1 wherein the sample collecting head comprises a flexible plate structure for collecting the sample of an object thereupon, the flexible plate structure having an aperture for accommodating therein a piercing portion of a tag and a passage connected to the aperture for releasing the piercing portion of the tag, the tag for attachment to the object.

8. A sample collecting device comprising:
an enclosure for enclosing a collected sample therein;
a sample holding mechanism disposed inside the enclosure for holding the collected sample at a predetermined location within the enclosure; and,
a sample access port disposed in a wall of the enclosure for enabling access to the collected sample at the predetermined location, the sample access port being sized such that an end portion of a tool is enabled to access the collected sample.

9. A sample collecting device as defined in claim 8 wherein the sample access port comprises a sealing membrane, the sealing membrane for being pierced by the tool to access the sample.

10. A sample collecting device as defined in claim 8 wherein the sample access port comprises a filter mechanism for filtering a portion of the collected sample prior removal by the tool.

11. A sample collecting device comprising:
an enclosure for enclosing a collected sample therein, the enclosure being shaped such that a plurality of sample collecting devices form one of a one-dimensional and a two-dimensional array suitable for use with an automated processing machine; and,
a sample holding mechanism disposed inside the enclosure for holding the collected sample at a predetermined location within the enclosure.

12. A sample collecting device as defined in claim 11 comprising a coupling mechanism for coupling the sample collecting device with at least an adjacent sample collecting device.

13. A sample collecting device as defined in claim 12 wherein the coupling mechanism comprises a first coupling element and a second coupling element, the first coupling element for coupling with a respective second coupling element of an adjacent sample collecting device and the second coupling element for coupling with a respective first coupling element of another adjacent sample collecting device.

14. A sample collecting device as defined in claim 11 comprising a sample access port disposed in a wall of the enclosure for enabling access to the collected sample at the predetermined location, the sample access port being sized such that an end portion of a tool of the automated processing machine is enabled to access the collected sample.

15. A sample collecting device as defined in claim 11 comprising an identifier for providing identification data to the automated processing machine, the identification data for being collected by the automated processing machine.

16. A sample collecting device comprising:
an enclosure for enclosing a collected sample therein;
a tag removable connected to the enclosure, the tag for being attached to an object associated with the collected sample;
a first identifier connected to the enclosure; and,
a second identifier connected to the tag, the second identifier being correlated to the first identifier.

17. A sample collecting device as defined in claim 16 wherein the first identifier and the second identifier comprise one of a barcode and a radio frequency identification chip.

18. A sample collecting device as defined in claim 16 wherein the tag is an ear tag for being attached to livestock.

19. A sample collecting device comprising:
a first enclosure portion having a first fastening mechanism; and,
a second enclosure portion having a second fastening mechanism, the second fastening mechanism for mating with the first fastening mechanism to fasten the second enclosure portion to the first enclosure portion in order to form an enclosure for enclosing a collected sample therein, wherein the second enclosure portion is fastened to the first enclosure portion in a substantially tamper evident fashion.

20. A sample collecting device as defined in claim 19 wherein the first enclosure portion has a first locking element and the second enclosure portion has a respective second locking element for engaging the first locking element, wherein the first locking element is shaped such that a portion of the first locking element is severed for disengaging from the second locking element.
